(19) United States
(12) Patent Application Publication
(10) Pub. No.: US 2010/0216441 A1
(43) Pub. Date: Aug. 26, 2010

(54) METHOD FOR PHOTO TAGGING BASED ON BROADCAST ASSISTED FACE IDENTIFICATION

(76) Inventors: Bo LARSSON, Malmo (SE); Jari SASSI, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/392,470

(22) Filed: Feb. 25, 2009

(51) Int. Cl. H04M 3/42; H04W 4/00

(52) U.S. Cl. 455/415; 455/414.1

(57) ABSTRACT

An electronic device, method, and system for obtaining data to be associated with a digital photograph captured with the device. The device includes a photograph management application for associating data with a digital photograph captured with the device. The photograph management application is configured to extract facial images from a photograph, determine a faceprint for the facial image, transmit the faceprint to remote mobile devices within a communication zone of the device that captured the image, receive data from a remote device recognizing the transmitted faceprint, and associate the data received from the remote device with the digital photograph.

### TECHNICAL FIELD OF THE INVENTION

The technology of the present disclosure relates generally to systems and methods for associating information with a digital photograph and, in particular, to automated systems and methods for obtaining information that relates to one or more images depicted in a digital photograph and associating that information with the photograph.

### BACKGROUND

Portable electronic devices such as mobile telephones have been popular for years and continue to increase in popularity. Over the years, mobile telephones have been provided with functions beyond their conventional voice communication functionality. For example, mobile telephones are now capable of data communications, video transfer, media reproduction, and commercial radio reception. Many electronic devices today include a camera function for taking pictures and/or video. In a typical mobile telephone with a camera, for example, the camera is mounted inside the housing of the phone. An opening is provided in the surface of the housing for the camera lens. The display can be used to target the lens, or a viewfinder is provided. A user will use the camera function by looking into the display or viewfinder and actuating a shutter release to capture an image.

Most photography now employs digital photography technology. Unlike conventional film photography, which has a cost of expended film associated with each picture taken, digital photography does not have an incremental cost associated with each picture. Therefore, a user of digital camera technology often captures many more photographs than he or she would have with a traditional film camera.

Typically, each digital photograph is stored as a file (automatically assigned a file name based on chronological order) within a directory (which is also assigned a directory name based on chronological order). There are numerous ways to organize and manage digital photographs. One approach to organizing and managing digital photographs is to organize the photographs within nested directories with file and directory names that are useful for identifying the image content of the photographs. This approach may require manually changing file names and re-organizing digital photographs into a nested directory structure, which may be time consuming and cumbersome. Further, such a solution does not facilitate searching for, or locating, a photograph if the appropriate directory name and file name are not known.

Several providers of “photo-album” software applications facilitate organization of digital photographs. Programs and applications may allow a user to associate text based tags with each photograph. A search feature then enables searching based on such text.

It has also been proposed to use face recognition technology to assist in associating text based tags with photographs within a collection. In a paper entitled “Leveraging Face Recognition Technology to Find and Organize Photographs”, authored by Andreas Girgensohn, John Adcock, and Lynn Wilcox, published in 2004, the authors propose use of a face detector to automatically extract images of faces from photographs. The face images are then sorted by similarity to a chosen model. A user interface presents the sorted face images so that a user may assign the face images to a person. This may include labeling the face images by typing the name of the person to whom the image corresponds. The label assigned to a face image is associated with the photograph from which the face image is extracted. As the user labels extracted face images, the face images become the model for use sorting additional face images. In an alternate variation, the system may assign a name to a face image and prompt the user to confirm the assignment. In yet another variation many similar face images may be presented for the user to label with a person's name (e.g. a bulk assignment approach). After labels are assigned to photographs, the photographs can be readily organized and sorted by the content of the labels.

### SUMMARY

According to one aspect of the disclosure, a method of operating a mobile device to obtain information related to a facial image depicted in a digital photograph captured by the mobile device is provided. In one embodiment, the method comprises capturing a digital photograph; creating a faceprint indicative of a facial image depicted in the photograph; transmitting the faceprint to one or more remote devices; obtaining identification data from at least one of the one or more remote mobile devices having a faceprint stored thereon that matches the transmitted faceprint; and associating at least a portion of the obtained identification data with the digital photograph.

According to one embodiment, transmitting the faceprint to the one or more remote mobile devices comprises transmitting the faceprint to one or more remote devices within a communication zone, the communication zone being a zone surrounding the mobile device in which the mobile device may electronically communicate via a local communication system.

According to one embodiment, wherein the local communication system is chosen from Bluetooth radio, infrared communication, near field communication, Wi-Fi, WLAN or a combination of two or more thereof.

According to one embodiment, transmitting the faceprint to the one or more remote mobile devices further comprises transmitting an identification element for identifying the mobile device to the one or more remote devices.

According to one embodiment, the identification element is a hash indicative of the phone number of the mobile device transmitting the faceprint.

According to one embodiment, the method further comprises creating an identification record comprising the faceprint obtained from the photograph and at least a portion of the identification data obtained from the one or more remote mobile devices.

According to one embodiment, the obtained identification data includes contact information related to the person associated with the faceprint.

According to one embodiment, the method further comprises creating a contact record comprising the faceprint and the contact information received from the at least one of the one or more remote mobile devices.

According to another aspect of the disclosure, a mobile device is provided comprising: a camera for capturing a digital photograph; a local communication system for communicating with one or more remote mobile devices within a communication zone surrounding the mobile device in which the mobile device may electronically communicate; a photograph management application configured to receive the digital photograph, obtain data related to the digital photograph, associate at least a portion of the data related to the digital photograph with the digital photograph, and extracting a facial image from the photograph; wherein when the photograph management application is loaded and executed and when executed causes the device to: extract a faceprint of a facial image depicted in the digital photograph; transmit the facial image to one or more remote mobile devices; obtain identification data from at least one of the one or more remote devices having a faceprint that matches the transmitted faceprint; and associating at least a portion of the obtained identification data with the digital photograph.

According to one embodiment, the mobile device further transmits an identification element to the one or more remote devices, the identification element identifying the mobile device.

According to one embodiment, the identification element is indicative of the phone number of the mobile device.

According to one embodiment, the identification element is a hash.

According to one embodiment, the photograph management application further causes the device to create a record comprising the faceprint and associate at least a portion of the obtained identification with the created record.

According to one embodiment, the obtained identification data includes contact information related to a person associated with the faceprint.

According to one embodiment, the mobile device further comprises a contact directory, and the contact directory causes the device to create a contact record comprising the faceprint and at least a portion of the obtained contact information.

According to still another aspect of the disclosure, a method of operating a mobile device to transmit data to a requesting device is provided. In one embodiment, the method comprises: receiving a transmission of a faceprint from a requesting device, the faceprint corresponding to a facial image from a digital photograph; determining if the received faceprint matches a faceprint stored on the mobile device; and transmitting information data associated with the stored faceprint to the requesting device upon a determination that the stored faceprint on the mobile device matches the faceprint transmitted by the requesting device.

According to one embodiment, the method comprises determining if the requesting device is known or unknown to the mobile device prior to transmitting the information data to the requesting device.

According to one embodiment, upon a determination by the mobile device that the requesting device is unknown to the mobile device, the mobile device (i) transmits designation data associated with the faceprint stored on the mobile device, or (ii) fails to transmit any information data to the requesting device.

According to one embodiment, the method comprises determining if the faceprint stored on the mobile device that matches the faceprint received from the requesting device corresponds to a faceprint identifying the user of the mobile device.

According to one embodiment, upon a determination that the faceprint stored on the mobile device that matches the faceprint received from the requesting device does not correspond to a faceprint identifying the user of the mobile device, the mobile device fails to transmit information data to the requesting device.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a schematic illustration of an exemplary mobile device suitable for use in accordance with aspects of the present invention;

FIG. 2 is a diagrammatic illustration of components of the mobile device of FIG. 1;

FIG. 3 is a flow chart illustrating an exemplary operation of a device and photograph management application for obtaining and associating data with a photograph in accordance with aspects of the present invention;

FIG. 4 is a schematic representation of an exemplary digital photograph obtained with a mobile device and a system for obtaining and associating data with the digital photograph in accordance with one embodiment of the present invention;

FIG. 5 is a ladder diagram illustrating exemplary operation of a photograph management application for obtaining and associating data with a photograph employing the system and components illustrated in FIG. 4;

FIG. 6 is a schematic illustration of an exemplary digital photograph and a system for obtaining and associating data with the digital photograph in accordance with another embodiment of the present invention; and

FIG. 7 is a flow chart illustrating exemplary operation of a device for sending information to a requesting device for associating data with a digital photograph captured by the requesting device.

### DETAILED DESCRIPTION OF EMBODIMENTS

Embodiments will now be described with reference to the drawings, wherein like reference numerals are used to refer to like elements throughout. It will be understood that the figures are not necessarily to scale.

The terms “electronic equipment” and “electronic device” include portable radio communication equipment. The term “portable radio communication equipment,” which herein after is referred to as a “mobile radio terminal,” includes all equipment such as mobile telephones, pagers, communicators, i.e., electronic organizers, personal digital assistants (PDAs), smartphones, portable communication apparatus or the like. The term “portable communication device” includes any portable electronic equipment including, for example, mobile radio terminals, mobile telephones, mobile devices, mobile terminals, communicators, pagers, electronic organizers, personal digital assistants, smartphones and the like. The term “portable communication device” also may include portable digital music players and/or video display devices.

In the present application, aspects of the invention are described primarily in the context of a mobile telephone. However, it will be appreciated that the invention is not intended to be limited to a mobile telephone and can be any type of portable electronic equipment.

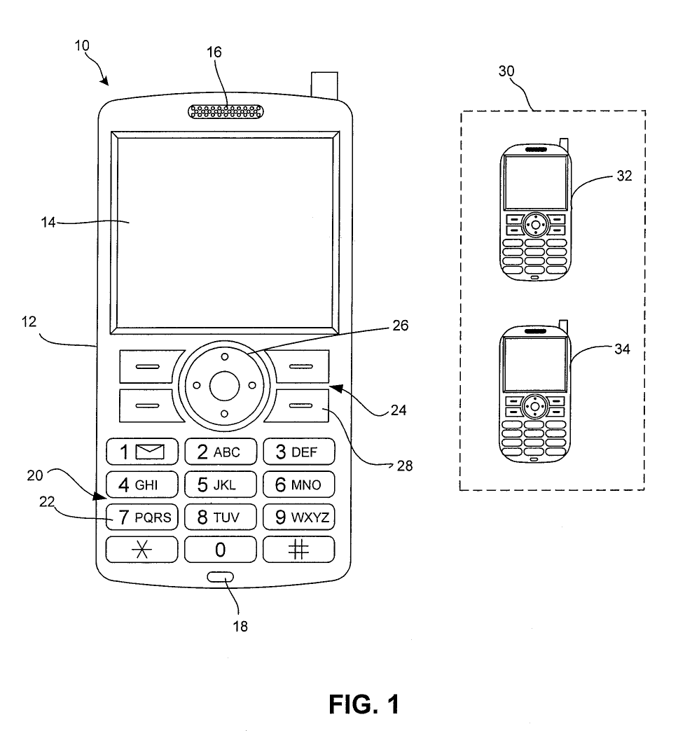

Referring to FIG. 1, an electronic device 10 suitable for use with the disclosed methods and applications is shown. The electronic device 10 in the exemplary embodiment is shown as a portable network communication device, e.g., a mobile telephone, and will be referred to as the mobile telephone 10. The mobile telephone 10 is shown as having a “brick” or “block” design type housing, but it will be appreciated that other type housings, such as clamshell housing or a slide-type housing, may be utilized without departing from the scope of the invention.

As illustrated in FIG. 1, the mobile telephone 10 may include a user interface that enables the user to easily and efficiently perform one or more communication tasks (e.g., enter in text, display text or images, send an E-mail, display an E-mail, receive an E-mail, identify a contact, select a contact, make a telephone call, receive a telephone call, etc.). The mobile phone 10 includes a housing 12, display 14, speaker 16, microphone 18, a keypad 20, and a number of keys 24. The display 14 may be any suitable display, including, e.g., a liquid crystal display, a light emitting diode display, or other display. The keypad 20 comprises a plurality of keys 22 (sometimes referred to as dialing keys, input keys, etc.). The keys 22 in keypad area 20 may be operated, e.g., manually or otherwise to provide inputs to circuitry of the mobile phone 10, for example, to dial a telephone number, to enter textual input such as to create a text message, to create an email, or to enter other text, e.g., a code, pin number, security ID, to perform some function with the device, or to carry out some other function.

The keys 24 may include a number of keys having different respective functions. For example, the key 26 may be a navigation key, selection key, or some other type of key, and the keys 28 may be, for example, soft keys or soft switches. As an example, the navigation key 26 may be used to scroll through lists shown on the display 14, to select one or more items shown in a list on the display 14, etc. The soft switches 28 may be manually operated to carry out respective functions, such as those shown or listed on the display 14 in proximity to the respective soft switch. The display 14, speaker 16, microphone 18, navigation key 26 and soft keys 28 may be used and function in the usual ways in which a mobile phone typically is used, e.g. to initiate, to receive and/or to answer telephone calls, to send and to receive text messages, to connect with and carry out various functions via a network, such as the Internet or some other network, to beam information between mobile phones, etc. These are only examples of suitable uses or functions of the various components, and it will be appreciated that there may be other uses, too.

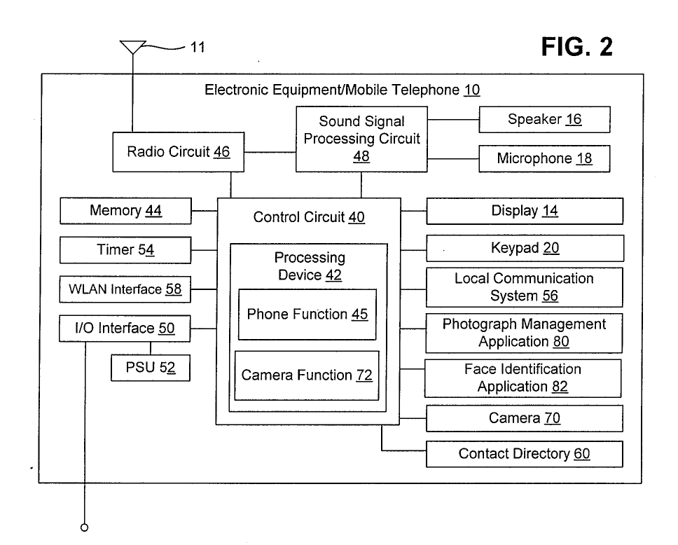

The mobile telephone 10 includes a display 14. The display 14 displays information to a user such as operating state, time, telephone numbers, contact information, various navigational menus, status of one or more functions, etc., which enable the user to utilize the various features of the mobile telephone 10. The display 14 may also be used to visually display content accessible by the mobile telephone 10. The displayed content may include E-mail messages, geographical information, journal information, photographic images, audio and/or video presentations stored locally in memory 44 (FIG. 2) of the mobile telephone 10 and/or stored remotely from the mobile telephone (e.g., on a remote storage device, a mail server, remote personal computer, etc.), information related to audio content being played through the device (e.g., song title, artist name, album title, etc.), and the like. Such presentations may be derived, for example, from multimedia files received through E-mail messages, including audio and/or video files, from stored audio-based files or from a received mobile radio and/or television signal, etc. The displayed content may also be text entered into the device by the user. The audio component may be broadcast to the user with a speaker 16 of the mobile telephone 10. Alternatively, the audio component may be broadcast to the user though a headset speaker (not shown).

The device 10 optionally includes the capability of a touchpad or touch screen. The touchpad may form all or part of the display 14, and may be coupled to the control circuit 40 for operation as is conventional.

Various keys other than those keys illustrated in FIG. 1 may be associated with the mobile telephone 10 may include a volume key, audio mute key, an on/off power key, a web browser launch key, an E-mail application launch key, a camera key to initiate camera circuitry associated with the mobile telephone, etc. Keys or key-like functionality may also be embodied as a touch screen associated with the display 14.

The mobile telephone 10 includes conventional call circuitry that enables the mobile telephone 10 to establish a call, transmit and/or receive E-mail messages, and/or exchange signals with a called/calling device, typically another mobile telephone or landline telephone. However, the called/calling device need not be another telephone, but may be some other device such as an Internet web server, E-mail server, content providing server, etc.

When the mobile telephone 10 is utilized as a camera as described herein, the display 14 may function as an electronic view finder to aid the user when taking a photograph or a video clip and/or the display may function as a viewer for displaying saved photographs and/or video clips. In addition, in a case where the display 14 is a touch sensitive display, the display 14 may service as an input device to allow the user to input data, menu selections, etc.

Referring to FIG. 2, a functional block diagram of the mobile telephone 10 is illustrated. The mobile telephone 10 includes a primary control circuit 40 that is configured to carry out overall control of the functions and operations of the mobile telephone 10. The control circuit 40 may include a processing device 42, such as a CPU, microcontroller or microprocessor. The processing device 42 executes code stored in a memory (not shown) within the control circuit 40 and/or in a separate memory, such as memory 44, in order to carry out conventional operation of the mobile telephone function 45.

The memory 44 may be, for example, a buffer, a flash memory, a hard drive, a removable media, a volatile memory and/or a non-volatile memory.

Continuing to refer to FIG. 2, the mobile telephone 10 includes an antenna 11 coupled to a radio circuit 46. The radio circuit 46 includes a radio frequency transmitter and receiver for transmitting and receiving signals via the antenna 11 as is conventional. The mobile telephone 10 generally utilizes the radio circuit 46 and antenna 11 for voice and/or E-mail communications over a cellular telephone network. The mobile telephone 10 further includes a sound signal processing circuit 48 for processing the audio signal transmitted by/received from the radio circuit 46. Coupled to the sound processing circuit 48 are the speaker 16 and the microphone 18 that enable a user to listen and speak via the mobile telephone 10 as is conventional. The radio circuit 46 and sound processing circuit 48 are each coupled to the control circuit 40 so as to carry out overall operation.

The mobile telephone 10 also includes the aforementioned display 14 and keypad 20 coupled to the control circuit 40. The device 10 and display 14 optionally includes the capability of a touchpad or touch screen, which may be all of part of the display 14. The mobile telephone 10 further includes an I/O interface 50. The I/O interface 50 may be in the form of typical mobile telephone I/O interfaces, such as a multi-element connector at the base of the mobile telephone 10. As is typical, the I/O interface 50 may be used to couple the mobile telephone 10 to a battery charger to charge a power supply unit (PSU) 52 within the mobile telephone 10. In addition, or in the alternative, the I/O interface 50 may serve to connect the mobile telephone 10 to a wired personal hands-free adaptor, to a personal computer or other device via a data cable, etc. The mobile telephone 10 may also include a timer 54 for carrying out timing functions. Such functions may include timing the durations of calls and/or events, tracking elapsed times of calls and/or events, generating timestamp information, e.g., date and time stamps, etc.

The mobile telephone 10 may include various built-in accessories. In one embodiment, the mobile telephone 10 also may include a position data receiver, such as a global positioning satellite (GPS) receiver, Galileo satellite system receiver, or the like. The mobile telephone 10 may also include an environment sensor to measure conditions (e.g., temperature, barometric pressure, humidity, etc.) in which the mobile telephone is exposed.

The mobile telephone 10 may include a local communication system 56 to allow for short range communication with another device. The local communication system 56 may also be referred to herein as a local wireless interface adapter. Suitable modules or systems for the local communication system include, but are not limited to, such as a Bluetooth radio, infrared communication module, near field communication module, Wi-Fi, and the like. The local communication system may also be used to establish wireless communication with other locally positioned devices, such as a wireless headset, a computer, etc. In addition, the mobile telephone 10 may also include a wireless local area network interface adapter 58 to establish wireless communication with other locally positioned devices, such as a wireless local area network, wireless access point, and the like. Preferably, the WLAN adapter 58 is compatible with one or more IEEE 802.11 protocols (e.g., 802.11(a), 802.11(b) and/or 802.11(g), etc.) and allows the mobile telephone 10 to acquire a unique address (e.g., IP address) on the WLAN and communicate with one or more devices on the WLAN, assuming the user has the appropriate privileges and/or has been properly authenticated. As used herein, the term “local communication system” encompasses a wireless local area network interface.

The local communication system and/or WLAN may be used, for example, to allow the device 10 to discover and connect to remote mobile devices such as devices 32 and 34 that are within a communication zone 30 (see FIG. 1). The communication zone 30 is defined by the region around the mobile device 10 within which the device may establish a communication session using the local communication system 56 and/or WLAN adapter 58. It will be appreciated, as further discussed below, that the communication need not be a traditional call answer session but may simply include the transmission of information to another device (such as by messaging systems including SMS, MMS, and the like, picture message, etc.)

As shown in FIG. 2, the processing device 42 is coupled to memory 44. Memory 44 stores a variety of data that is used by the processor 42 to control various applications and functions of the device 10. It will be appreciated that data can be stored in other additional memory banks (not illustrated) and that the memory banks can be of any suitable types, such as read-only memory, read-write memory, etc.

The device 10 may include a contact directory 60 for storing a plurality of contact records. Each contact record may include any desirable information related to the contact including traditional contact fields such as the contact's name, telephone number(s), e-mail address(es), business or street addresses, birth date, anniversary date, etc. The contact directory serves its traditional purpose of providing a network address (e.g., telephone number, e-mail address, text address, etc.) associated with the person in the contact record to enable any of the telephone application or messaging application to initiate a communication session with the network address via the network communication system.

The contact record may also include a call line identification photograph, which may be, for example, a facial image of the contact. The telephone functionality 45 may drive a user interface to display the call line identification photograph when a caller ID signal of an incoming call matches a telephone number in the contact record in which the call line identification record is included.

Mobile telephone 10 includes a variety of camera hardware 70 suitable to carry out aspects of the present invention. The camera hardware 70 may include any suitable hardware for obtaining or capturing a photograph, for example, a camera lens, a flash element, as well as a charge-coupled device (CCD) array or other image capture device, an image processing circuit, and the like. The camera lens serves to image an object or objects to be photographed onto the CCD array. Captured images received by the CCD are input to an image processing circuit, which processes the images under the control of the camera functions 72 so that photographs taken during camera operation are processed and, image files corresponding to the pictures may be stored in memory 44, for example.

When wishing to take a picture with the mobile telephone 10, a user presses a button or other suitable mechanism to initiate the camera circuitry 70 and/or camera function 72. The control circuit processes the signal generated from the user pressing the appropriate buttons. The user is then able to take a photograph and/or video clip in a conventional manner. In this example, the image received by the CCD sensor may be provided to the display 14 via the camera function 72 so as to function as an electronic viewfinder.

The device 10 includes a photograph management application 80. The photograph management application 80 is configured, in one aspect, to obtain an information record comprising information related to a captured digital photograph, and associate at least a portion of the information related to the digital photograph with the captured photograph. The information or data may be associated with the captured photograph in any suitable form such as, for example, text based metadata. The text based metadata may identify content depicted in the digital photograph such that a collection of photographs can be readily searched and/or sorted based on content (e.g., searched or sorted using the metadata.

Metadata be structured in any suitable record including, but not limited to, EXIF, an XML record, and the like. Exemplary metadata may include, but is not limited to, a date element identifying the date the photograph was taken, a time element identifying the time the photograph was taken, a location element identifying the location where the photograph was taken, primary content elements that include a category identifier element, and the like. The location element may be determined in any suitable manner, and may include identification of any permutation of GPS latitude/longitude, country, city, and/or other location identification information such as, for example, identification of an attraction. The photograph management application may extract the location element from another program (e.g., a location program such as a GPS database) at the time the digital photograph is taken. The location program may be local in the mobile device, or may be operated by a remote directory server. Alternatively, the user may manually enter the location element into the device.

To determine the primary content category based on the subject of the photograph, the photograph management application may access a primary content database (not shown) that includes content recognition data, for one or more predetermined categories, for categorizing primary content of a photograph. The predetermined categories are not limited and may include, for example, people, animals, attractions, and the like. The content recognition data may be in the form of a model photograph to which the image or images in the photograph may be compared. Alternatively, the content recognition data may be in the form of feature data representative of the category that may be applied to extracted features from the photograph to determine to which category the primary content best corresponds. The primary content database may be local on the mobile device or operated on a remote directory server.

After, or in the alternative to, determining the primary content category for the photograph, the photograph management application may obtain more specific information about the subject matter depicted in the photograph. Such information may be category specific information (e.g., a specific attraction name, a specific breed of dog, etc.). The specific category data may be obtained, in one aspect, by accessing data stored by the mobile device or by obtaining such additional information from a directory server.

In one embodiment, for example, the photograph management application may determine that the primary content category for the photograph is “people.” To associate more specific information with the photograph, the photograph management application may access, for example, the contact directory to identify the person depicted in the digital photograph. More specifically, the photograph management application may access a stored record depicting a facial image (e.g., such as a photograph or faceprint), e.g., the call line identification photographs of the contact directory or a record stored by the photograph management application 80, to compare the image of the person depicted in the digital photograph with the stored facial image record. This may be accomplished using, for example, a facial identification application 82. The facial identification application 82 may be configured to extract a facial image from the photograph, determine/create a faceprint of the facial image, and compare the faceprint determined from the photograph with a faceprint stored on the device (such as a faceprint relating to the facial image in a call line identification photograph). If the faceprint determined from the photograph is sufficiently similar to the stored faceprint, the photograph management application may associate at least a portion of the information associated with the stored faceprint (such as information from a contact record, e.g., a person's name) with the captured photograph. Faceprints are discussed in more detail herein. The photograph management application may be configured to perform such a comparison for each facial image depicted in the captured photograph.

In accordance with the present invention, a method is provided to obtain information about an object depicted in a photograph captured with the mobile device and associating that information with the captured photograph. In one aspect, the method is particularly suitable for obtaining information about people whose images are deposited in a digital photograph captured with a mobile device and will be discussed with particular reference thereto.

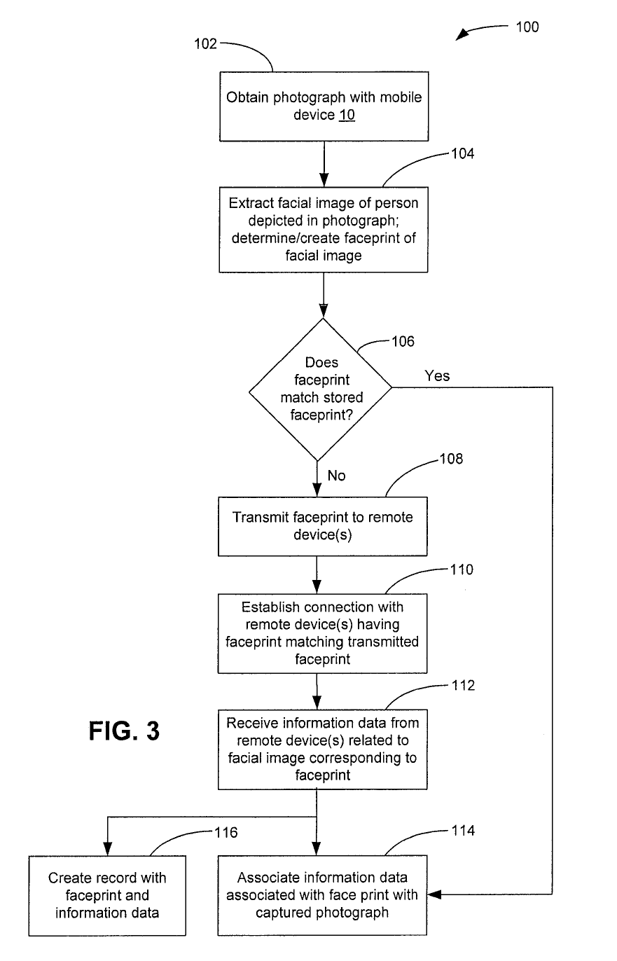

Referring to FIG. 3, a flow chart is shown depicting an exemplary aspect of operating the photograph management application to obtain information about a person depicted in a photograph captured with the mobile device 10 and associating that information with the captured photograph. The method 100 includes, at functional block 102, obtaining a digital photograph with the mobile device 10. At functional block 104, the photograph management application 80 (and particularly facial identification application 82) extracts a facial image of a person depicted in the digital photograph and creates a faceprint of the facial image. The facial identification application 82 includes an algorithm for converting the extracted facial image into a mathematical description of the facial image, which is referred to herein as the faceprint of the facial image. The faceprint may be based on various landmarks that make up facial features. At functional block 106, the facial identification application 82 determines if the faceprint matches a facial image stored on mobile device 10. This comparison may be done by converting a stored facial image, e.g., an image associated with a contact record, to a faceprint and comparing that to the faceprint determined from the captured images, or by comparison to an already stored faceprint. If the faceprint extracted from the photograph matches a stored faceprint (or a faceprint determined from a stored image), the photograph management application may proceed to functional block 114 and information associated with the stored faceprint may be associated with the captured photograph (as described above). This aspect of method 100 was described above.

If the faceprint determined from the facial image in the photograph does not match a stored faceprint, the method proceeds to functional block 108, and the mobile device 10 transmits the faceprint to one or more remote devices. Generally, transmitting the faceprint to the remote device(s) includes transmitting to one or more remote devices within a communication zone via a local communication system, such as local communication system 56 or WLAN 58. Transmitting may be accomplished for example, using a local wireless interface such as, for example, Bluetooth radio, an infra red communication module, a near field communication module, or other system for short range communication with another compatible device. Transmitting the faceprint may also be accomplished using the WLAN interface. In one aspect, transmitting via a local communication system may be conducted via a broadcast of the faceprint to all the remote devices within the communication zone 30. In another aspect, transmitting may be accomplished by looking for a device in range, i.e., in the communication zone, and contacting each device individually, one by one.

Transmitting a faceprint rather than the image itself may be desirable in that a faceprint determined from a photograph may be relatively small (e.g., about 1 kilobyte) as compared to the size of the digital photograph. This may make the transmission of the faceprint to remote devices easier for a mobile device (in terms of both time to process or even ability for other devices to receive the transmission).

As depicted in functional block 110, if a remote device to which the faceprint has been transmitted (which may also be referred to as the receiving device) has a stored faceprint matching the transmitted faceprint, a communication session is established between the mobile device 10 (which may also be referred to herein as the sending device or the requesting device) and the remote device(s) (which may also be referred to herein as the receiving device(s)). If a remote device does not have a stored faceprint matching the transmitted faceprint, no communication session is established (and the transmitted faceprint is discarded from the remote device).

The facial identification application may be programmed to define the parameters evaluated and the degree of correlation required for two faceprints to be considered as matching. It may be possible that more than one faceprint on the receiving device may be found to match the faceprint received from the requesting device. The applications on the receiving device may be programmed to provide a score for each potential match, the score being indicative of the relatedness of the stored faceprints on the receiving device to the faceprint sent from the requesting device. In this instance, the receiving device may be programmed to send information associated with the faceprint having a higher correlation or match to the faceprint sent from the requesting device.

At functional block 112, the mobile device 10 receives data sent from the remote device with which a communication session has been established (based on the remote device having a faceprint matching the transmitted faceprint). At functional block 114, the photograph management application associates at least a portion of the data received from the remote device with the captured photograph.

In accordance with the method, as illustrated in functional block 116, the photograph management application 80 may create a record with the facial image (or faceprint) and the data received from the remote device. In this sense, the next time a photograph is taken with a facial image that matches the now stored facial image (and/or faceprint), the mobile device 10 may proceed from functional block 106 to functional block 114 to associate information with the photograph without the need to re-obtain the information such as by the operations performed at functional blocks 108-112. The record created and/or stored at functional block 116, may be created, for example, as a contact record and stored in the contact directory 60.

The data transmitted from a receiving device to the requesting device is not particularly limited and may be in any suitable form including, for example, metadata. The type of information being transmitted also is not limited and may include, for example, a name, address, e-mail address, phone number, etc.

As illustrated above, the method allows for data/information related to a facial image depicted in a photograph to automatically be obtained from another individual and associated with a photograph. Where a user may not already have a record with data related to an individual depicted in a photograph, the method does not require that a user of a device manually input the data to be associated with a photograph. Further, the user does not have to request or ask the person whose image is depicted in the photograph for such information. Rather, by transmitting a faceprint to remote devices within a communication zone, a device may automatically obtain information about a person depicted in the photograph and automatically tag the photograph with at least a portion of that information. This reduces manual input requirements and enhances various features of a mobile device such as, for example, the photograph management application.

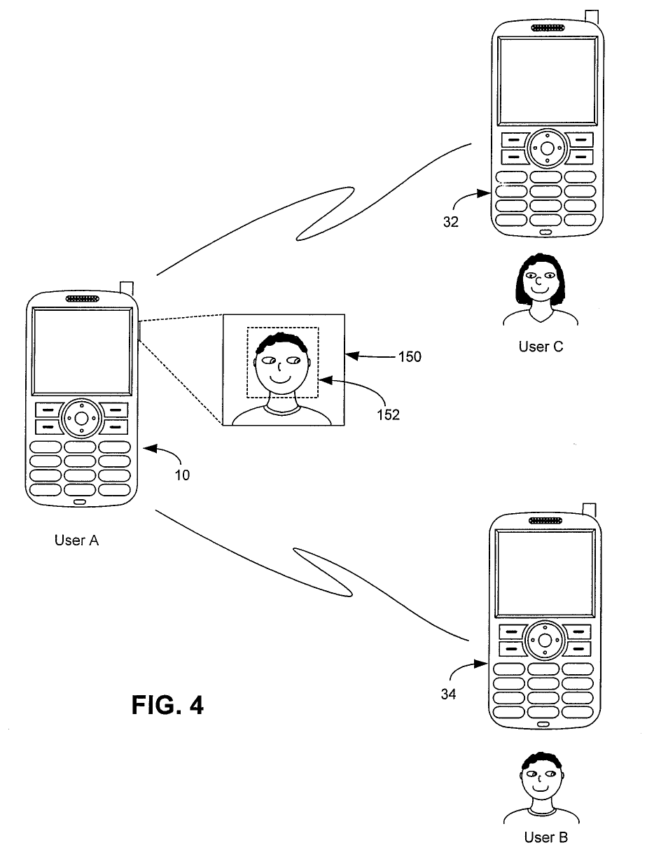

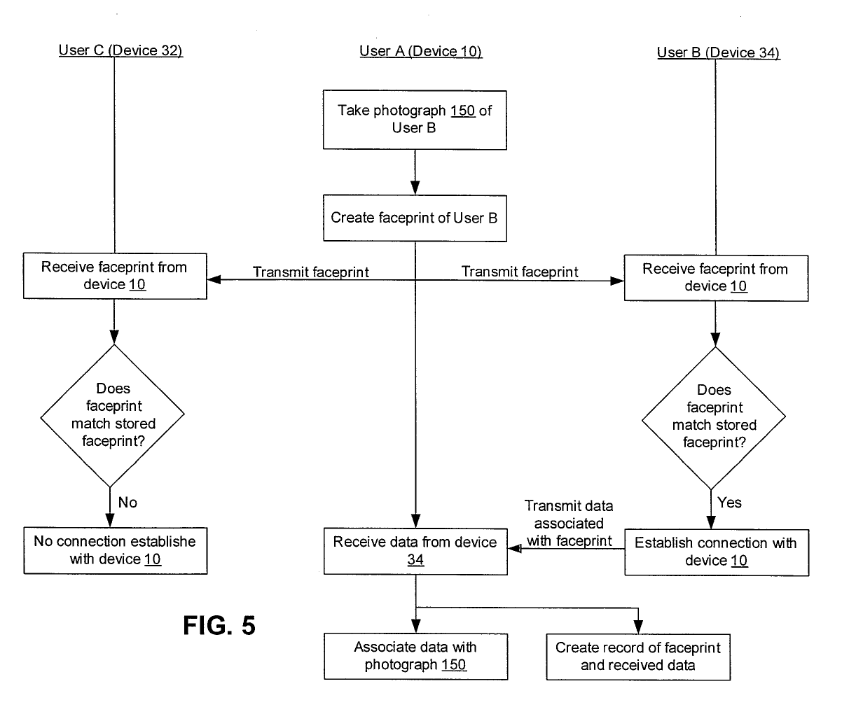

The method and system may be further understood with reference to FIGS. 4 and 5. Referring to FIGS. 4 and 5, mobile device 10 is operated by User A to take a digital photograph 150 of User B. The photograph management application 80, and in particular facial identification application 82, may extract a facial image 152 from the photograph 150 and create a faceprint of the facial image 152. For purposes of this example, mobile device 10 determines that it does not have a stored faceprint (or facial image from which a faceprint is determined) that matches the faceprint determined from facial image 152. Device 10 then transmits the faceprint related to facial image 152 to device 32 (operated by User C) and device 34 (operated by User B), which are present within communication zone 30 (see FIG. 1). Device 32 determines if it has a faceprint that matches the faceprint transmitted by device 10. In this example, device 32 does not have a matching faceprint, and no communication session is established. Device 34 also determines if the faceprint transmitted by device 10 matches a faceprint stored on device 34. In this example, the faceprint transmitted by device 10 matches a faceprint stored on device 34, e.g., User B's own stored faceprint. Device 34 then establishes a communication session with device 10 and transmits data to device 10. Device 10 receives the data from device 34 and associates at least a portion of the data received from device 34 with the captured photograph 150. As previously discussed, the photograph management application 80 may also create a record of the faceprint and the data received from device 34 and store such record on the device 10.

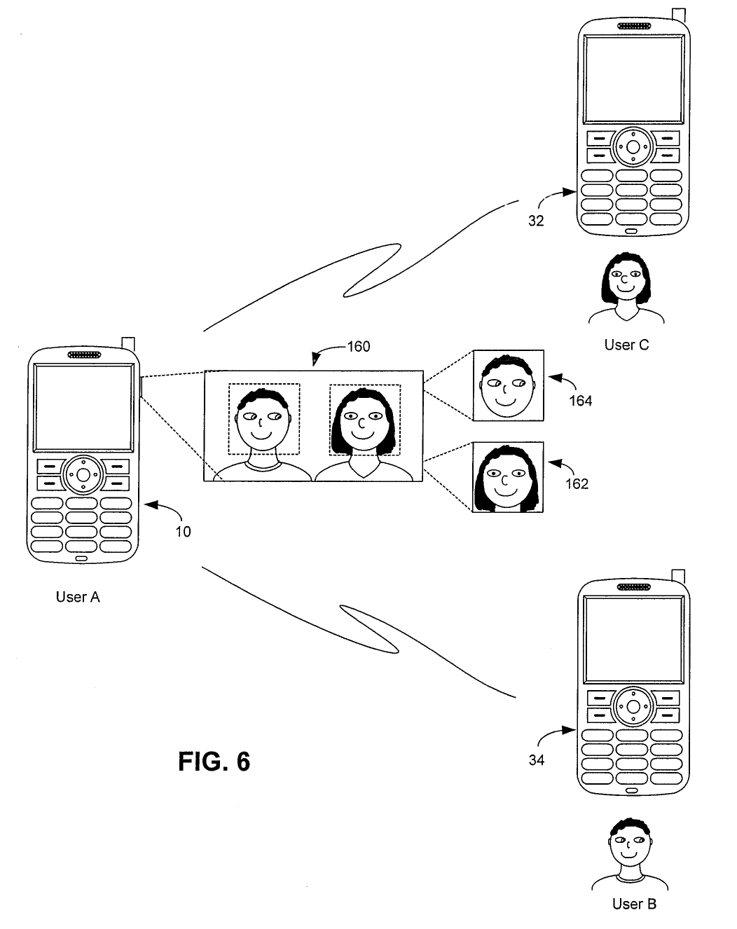

It will be appreciated that the method may be used to obtain data related to more than one facial image depicted in a photograph. Referring to FIG. 6, for example, User A may use device 10 to take a photograph 160 depicting both User B and User C. The photograph management application 80 (and particularly facial identification application 82) may extract facial image 162 of User C and facial image 164 of User B and create separate faceprints of the respective facial images. Device 10 may then transmit the respective faceprints to device 32 and device 34 (if the devices are within the communication zone 30 (see FIG. 1). The respective devices may then determine if they have a stored faceprint that matches one of the transmitted faceprints. If they do, they may establish a communication session with device 10 and transmit data or information to device 10. For example, device 32 may have a stored faceprint that matches the faceprint related to facial image 162 (of User C), but not have a stored faceprint that matches the faceprint related to facial image 164 (of User B). Device 32 then establishes a communication session with device 10 and transmits information to device 10. Device 34 may go through a similar process and determine that it has a stored faceprint that matches the transmitted faceprint related to facial image 164 (of User B) but not a faceprint that matches the transmitted faceprint related to facial image 162 (of User C).

The process of transmitting multiple faceprints may be accomplished in separate transmissions or in a single transmission. For example, device 10 may first transmit a faceprint related to facial image 162 to devices 32 and 34, receive a response (if one of the receiving devices has a matching faceprint), and associate the data received from at least one of devices 32 or 34 with the photograph 160 (and optionally create a record of the data and facial image). After this has been completed the device 10 may then transmit the faceprint associated with facial image 164 to devices 32 and 34 and repeat the process.

Alternatively, multiple faceprints may be transmitted substantially simultaneously to one or more devices within the communication zone. In such situations, it may be appropriate for the transmitted faceprints to include a code or identifier that may be included in the information data sent to the requesting device form the receiving device such that the requesting device may determine which faceprint (or facial image) the data should be associated with.

The requesting device (e.g., device 10) may, in addition to transmitting the faceprint, also transmit an identification element to identify the requesting device to the remote device(s) to whom the transmission is being sent. The identification element may be any suitable identifier such as, for example, an identifier indicative of the telephone number of the requesting device. In one embodiment, the requesting device (transmitting the faceprint determined from the captured photograph) may transmit a hash of the requesting device's phone number, which the receiving device(s) may use to determine if the requesting device is known or unknown to the receiving device (and the receiving user). The receiving device may be able to determine if the transmitted hash corresponds to a telephone number in the receiving device's contact record.

From the perspective of the devices receiving the transmitted faceprint (e.g., devices 32 and 34), such devices may be provided with features to control whether information is transmitted to the requesting device (e.g., device 10). For example, a user of a device may not want to automatically transmit information to a requesting device if the requesting device is unknown to the user of the receiving device. If a requesting device is unknown to the receiving device, the user of the receiving device may not want to transmit any information to the requesting device or may only want to transmit a limited amount of information to the requesting device.

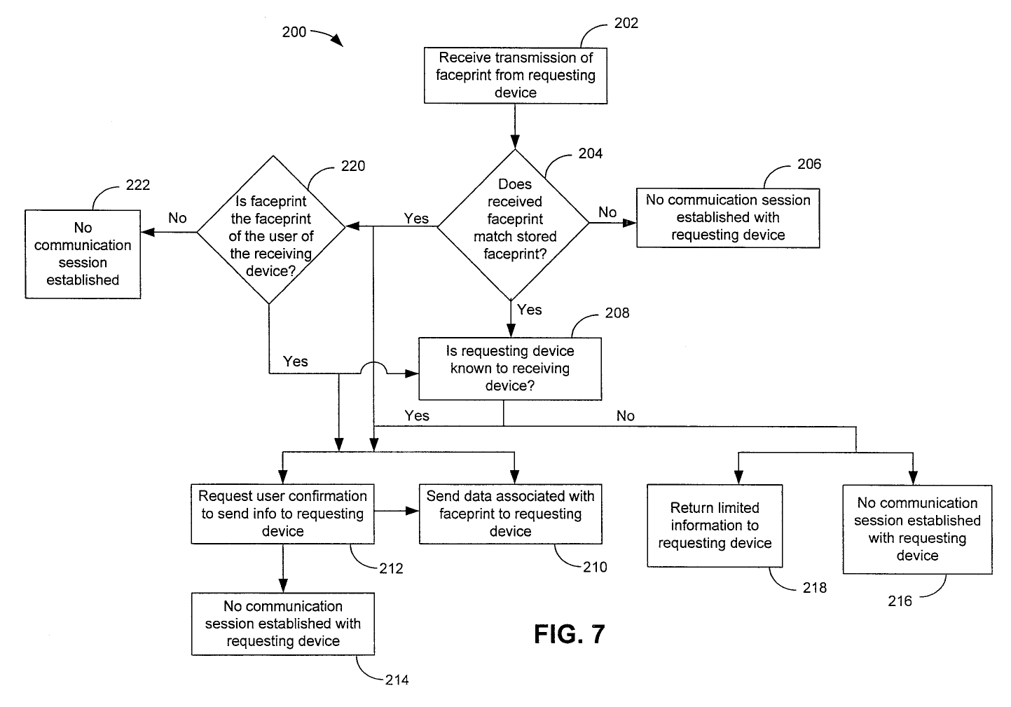

Referring to FIG. 7, a method 200 is shown for a receiving device (e.g., device 32 or 34) to determine if the receiving device should transmit any information or a limited amount of information to a requesting device (e.g., device 10) in response to receiving a faceprint transmission from the requesting device. At functional block 202, the receiving device receives a transmission of a faceprint from a requesting device. At functional block 204, the receiving device determines if the received faceprint matches a stored faceprint on the receiving device. If the received faceprint does not match, the process flows to functional block 206, and no communication session is established with the requesting device.

If the received faceprint matches a stored faceprint on the receiving device, the process may flow to functional block 210, where the receiving device establishes a communication session with the requesting device and automatically transmits a predetermined set of data to the requesting device (or block 212 to request confirmation from the user the information should be sent).

In another embodiment, if the received faceprint matches a stored faceprint on the receiving device, the process may flow to functional block 208, where the receiving device determines if the requesting device is known to the receiving device. For example, as discussed above, the requesting device may transmit an identification element as part of its transmission, and the receiving device may determine if the receiving device recognizes the requesting device based on the identification element. If the requesting device does not recognize or otherwise know the requesting device, the process may flow to (i) functional block 216 where no communication session is established with the requesting device, or (ii) functional block 218 where the receiving device establishes a communication session with the requesting device but only transmits a limited amount of information to the requesting device. The limited information that the receiving device sends to the requesting device may be referred to as designation data, and may be any type and/or amount of information as selected or desired (by the user of the receiving device) that symbolizes or characterizes the device or user but does not provide any detailed information about the device or user. Examples of designation information that may be sent to an unrecognized requesting device may be, for example, a first name or nickname associated with the faceprint stored on the receiving device. It will be appreciated that programs on the receiving device may drive the device to generate a request (displayed on the user interface) for confirmation that no information or a limited amount of information should be sent to the requesting device and/or to allow the user of the receiving device to select what information should be sent to the requesting device.

If the requesting device is known or recognized by the receiving device, the process may flow to (i) functional block 210, where the receiving device establishes a communication session with the requesting device and automatically transmits a predetermined set of information related to the stored, matching faceprint to the requesting device, or (ii) functional block 212, where the receiving device drives a user interface to display a prompt requesting the user of the receiving device to confirm that the information should be sent to the requesting device. If the user confirms that the information should be sent, the process proceeds to functional block 210, where a communication session is established between devices and the information is sent from the receiving device to the requesting device. If the user does not confirm that the information should be sent, the process proceeds to functional block 214, where no communication session is established, and the received faceprint is discarded. It will be appreciated that the operation being performed at functional block 212 may include a user selecting the type and/or amount of the receiving device information being sent to the requesting device.

Other privacy layers may be provided for the receiving device(s) with respect to whether information should be sent to a requesting device. For example, a receiving device may have a plurality of faceprints stored thereon, which may correspond to different people. Further, the respective faceprints may each have information or data associated therewith that relate to information about the person to which a respective faceprint corresponds. For example, referring to FIG. 6, device 32 may have a stored faceprint corresponding to User B and a stored faceprint corresponding to User C. Device 32 may be User C's device, but it could be possible for device 32 to recognize a faceprint received from device 10 as corresponding to a stored faceprint identifying User B and transmit stored information related to User B to the requesting device. For privacy concerns, such as to avoid sending third party information to a requesting device, a device may be programmed such that a stored faceprint is recognized as the faceprint of the user of that particular device. And from this feature, the determination of whether information should be sent to a requesting device may be made.

For example, referring again to FIG. 7, if, at functional block 204, the receiving device determines that the faceprint received from the requesting device matches a stored faceprint, the process may flow to functional block 220, where the receiving device determines if the received faceprint corresponds to the faceprint identifying the user of the receiving device. For example, referring back to FIG. 6, device 32 will evaluate whether the received faceprints corresponding to facial images 162 and 164 match a stored faceprint on device 32 that is designated as User C's faceprint (device 32's user's faceprint). In this example, the received faceprint related to facial image 162 does not match the User B's own stored faceprint, and the process proceeds to functional block 222, where no communication session is established (and the received faceprint may be discarded). When device 34 receives a faceprint corresponding to facial image 164, device 34 determines that the received faceprint matches the stored faceprint corresponding to User B (device 34's user's faceprint), and the process may proceed to functional block 208 and determine if information/data should be transmitted to the requesting device.

It will also be appreciated that the process could proceed from functional block 220 directly to functional block 210 or 212 and transmit (or request user confirmation to transmit) the information to the requesting device.

A person having skill in the art of programming will, in view of the description provided herein, be able to ascertain and program an electronic device or provide a system to carry out the functions described herein with respect to a photograph management application, a facial identification application, and other application programs. Accordingly, details as to specific programming code have been left out for the sake of brevity. Also, while the various applications are carried out in memory of the respective electronic device 10 (or 32 or 34), it will be appreciated that such functions could also be carried out via dedicated hardware, firmware, software, or combinations of two or more thereof without departing from the scope of the present invention.

Although certain embodiments have been shown and described, it is understood that equivalents and modifications falling within the scope of the appended claims will occur to others who are skilled in the art upon the reading and understanding of this specification.

What is claimed is:

1. A method of operating a mobile device to obtain information related to a facial image depicted in a digital photograph captured by the mobile device, the method comprising:
capturing a digital photograph;
creating a faceprint indicative of a facial image depicted in the photograph;
transmitting the faceprint to one or more remote devices;
obtaining identification data from at least one of the one or more remote mobile devices having a faceprint stored thereon that matches the transmitted faceprint; and
associating at least a portion of the obtained identification data with the digital photograph.

2. The method of claim 1, wherein transmitting the faceprint to the one or more remote mobile devices comprises transmitting the faceprint to one or more remote devices within a communication zone, the communication zone being a zone surrounding the mobile device in which the mobile device may electronically communicate via a local communication system.

3. The method of claim 2, wherein the local communication system is chosen from Bluetooth radio, infrared communication, near field communication, Wi-Fi, WLAN or a combination of two or more thereof.

4. The method of claim 1, wherein transmitting the faceprint to the one or more remote mobile devices further comprises transmitting an identification element for identifying the mobile device to the one or more remote devices.

5. The method of claim 4, wherein the identification element is a hash indicative of the phone number of the mobile device transmitting the faceprint.

6. The method of claim 1, further comprising creating an identification record comprising the faceprint obtained from the photograph and at least a portion of the identification data obtained from the one or more remote mobile devices.

7. The method of claim 1, wherein the obtained identification data includes contact information related to the person associated with the faceprint.

8. The method of claim 7, further comprising creating a contact record comprising the faceprint and the contact information received from the at least one of the one or more remote mobile devices.

9. A mobile device comprising:
a camera for capturing a digital photograph;
a local communication system for communicating with one or more remote mobile devices within a communication zone surrounding the mobile device in which the mobile device may electronically communicate;
a photograph management application configured to receive the digital photograph, obtain data related to the digital photograph, associate at least a portion of the data related to the digital photograph with the digital photograph, and extracting a facial image from the photograph;
wherein when the photograph management application is loaded and executed and when executed causes the device to:
extract a faceprint of a facial image depicted in the digital photograph;
transmit the facial image to one or more remote mobile devices;
obtain identification data from at least one of the one or more remote devices having a faceprint that matches the transmitted faceprint; and
associating at least a portion of the obtained identification data with the digital photograph.

10. The mobile device of claim 9, wherein the mobile device further transmits an identification element to the one or more remote devices, the identification element identifying the mobile device.

11. The mobile device of claim 10, wherein the identification element is indicative of the phone number of the mobile device.

12. The mobile device of claim 11, wherein the identification element is a hash.

13. The mobile device of claim 9, wherein the photograph management application further causes the device to create a record comprising the faceprint and associate at least a portion of the obtained identification with the created record.

14. The method of claim 9, wherein the obtained identification data includes contact information related to a person associated with the faceprint.

15. The method of claim 14, wherein the mobile device further comprises a contact directory, and the contact directory causes the device to create a contact record comprising the faceprint and at least a portion of the obtained contact information.

16. A method of operating a mobile device to transmit data to a requesting mobile device, the method comprising:
receiving a transmission of a faceprint from a requesting device, the faceprint corresponding to a facial image from a digital photograph;
determining if the received faceprint matches a faceprint stored on the mobile device; and
transmitting information data associated with the stored faceprint to the requesting device upon a determination that the stored faceprint on the mobile device matches the faceprint transmitted by the requesting device.

17. The method of claim 16, comprising determining if the requesting device is known or unknown to the mobile device prior to transmitting the information data to the requesting device.

18. The method of claim 17, wherein, upon a determination by the mobile device that the requesting device is unknown to the mobile device, the mobile device (i) transmits designation data associated with the faceprint stored on the mobile device, or (ii) fails to transmit any data to the requesting device.

19. The method according to claim 16, comprising determining if the faceprint stored on the mobile device that matches the faceprint received from the requesting device corresponds to a faceprint identifying the user of the mobile device.

20. The method according to claim 19, wherein, upon a determination that the faceprint stored on the mobile device that matches the faceprint received from the requesting device does not correspond to a faceprint identifying the user of the mobile device, the mobile device fails to transmit information data to the requesting device
